(19) United States
(12) Patent Application Publication
(10) Pub. No.: US 2026/0147712 A1
(43) Pub. Date: May 28, 2026

(54) METHOD AND APPARATUS FOR PREDICTING BLOCKS WITHIN A CACHE LINE FOR FETCH REQUESTS

(71) Applicant: International Business Machines Corporation, Armonk, NY (US)

(72) Inventors: Craig R. Walters, Highland, NY (US); Ram Sai Manoj Bamdhamravuri, Austin, TX (US); Alper Buyuktosunoglu, White Plains, NY (US); David Trilla Rodríguez, New York, NY (US); Deanna Postles Dunn Berger, Hyde Park, NY (US)

(73) Assignee: International Business Machines Corporation, Armonk, NY (US)

(21) Appl. No.: 18/962,108

(22) Filed: Nov. 27, 2024

(51) Int. Cl. G06F 12/0875; G06F 9/38

(52) U.S. Cl. CPC G06F 12/0875; G06F 9/3802; G06F 2212/452

(57) ABSTRACT

An apparatus for predicting cache blocks within a cache line for fetch requests is disclosed. A processing unit includes a processor core, a cache and a cache block access predictor. The cache includes multiple cache lines, and each one of the cache lines includes a set of cache blocks. The cache block access predictor includes a cache block access tracker having a set of counters, each corresponding to one of the cache blocks within a cache. The set of counters keeps track of specific one or more cache blocks within a cache line that are actually utilized by the processor core after a fetch request. The cache block access predictor also includes a cache block selector for selecting only the specific one or more cache blocks, instead of all cache blocks, to be returned to the processor core in a subsequent fetch request for the same cache line.

### TECHNICAL FIELD

The present invention relates to cache line management within a processor in general, and in particular, to a method and apparatus for predicting blocks within a cache line for fetch requests.

### BACKGROUND

A multiprocessor (MP) computer system typically includes multiple processing units, each including one or more processor cores. The processing units are all coupled to an interconnect fabric, which typically comprises one or more address, data and control buses. Coupled to the interconnect fabric are one or more system memories, which together form the lowest level of processor-addressable memory in the multiprocessor computer system and which are generally accessible for read and write access by all processing units.

Cache memories are commonly utilized to temporarily buffer memory blocks from system memory that are likely to be accessed by a processor core in order to speed up processing by reducing access latency introduced by having to load needed data and instructions from the system memory. In some MP systems, a vertical cache hierarchy associated with each processor core includes at least two levels, commonly referred to as level one (L1) cache and level two (L2) cache. The L1 cache is generally a relatively small cache that is characterized by the lowest access latency. In many cases, the L1 cache is a private cache, meaning that the L1 cache is associated with a specific processor core and cannot be directly accessed by other processor cores in the MP system. The L2 cache is generally a relatively larger cache having a higher access latency than the associated L1 cache. In some operating modes or implementations, an L2 cache can be shared by multiple processor cores. In some cases, the vertical cache hierarchy associated with a given processor core may include additional lower levels, such as a level three (L3) cache.

Existing cache only manages data at a full cache line granularity. While this simplifies cache design, it is not necessarily optimal for performance at the micro-architectural level because a processor core sometimes may not actually make use of a full cache line's worth of data. Yet, even when a processor core only wants a subset of the information within a cache line, the information within the entire cache line still need to be transferred in order to complete the fetch request. As a result, subsequent fetch operations will be delayed because the data bus is busy transferring data from the one cache line for multiple cycles.

Consequently, it would be desirable to provide an improved method and apparatus for handling fetch requests.

### SUMMARY

In accordance with one embodiment of the present invention, a processing unit includes a processor core, a cache and a cache block access predictor. The cache includes multiple cache lines, and each one of the cache lines includes a set of cache blocks. The cache block access predictor includes a cache block access tracker having a set of counters, each corresponding to one of the cache blocks within a cache. The set of counters keeps track of a specific one or more cache blocks within a cache line that are actually utilized by the processor core after a fetch request. The cache block access predictor also includes a cache block selector for selecting only the specific one or more cache blocks, instead of all cache blocks, to be returned to the processor core in a subsequent fetch request for the same cache line.

### BRIEF DESCRIPTION OF THE DRAWINGS

FIG. 1 is a block diagram of a data processing system in which one embodiment of the present invention can be incorporated;

FIG. 2 is a block diagram of a processor core within the data processing system in FIG. 1, according to one embodiment of the present invention;

FIG. 3 is a block diagram of a cache block access tracker within the processor core in FIG. 2, according to one embodiment of the present invention;

FIG. 4 is a flowchart illustrating a method for predicting cache blocks within a cache line for fetch requests, according to one embodiment of the present invention; and

FIG. 5 is a block diagram of a computing environment in which an embodiment of present invention can be incorporated.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION

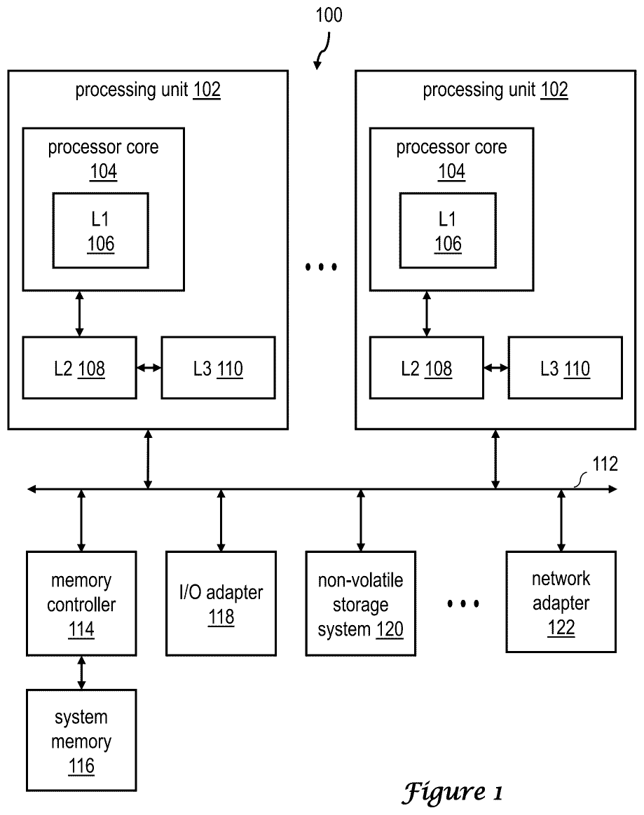

Referring now to the drawings, and in particular to FIG. 1, there is illustrated a block diagram of a data processing system in which one embodiment of the present invention can be incorporated. As shown, a data processing system 100 includes one or more processing units 102 that process instructions and data. Each processing unit 102 may be realized as a respective integrated circuit having a semiconductor substrate in which integrated circuitry is formed, as is known in the art. In at least some embodiments, processing units 102 can generally implement any one of a number of commercially available processor architectures, for example, POWER, ARM, Intel x86, NVidia, etc. In the depicted example, each processing unit 102 includes one or more processor cores 104 each coupled to a respective vertical cache hierarchy providing low latency access to instructions and operands likely to be read and/or written by the associated processor core 104. In the depicted example, the vertical cache hierarchy coupled to each processor core 104 includes at least a store-through L1 cache 106 characterized by a relatively smaller storage capacity and lower access latency and a store-in L2 cache 108 characterized by a relatively larger storage capacity and higher access latency.

Processing units 102 are coupled for communication with each other and with other system components by a system interconnect 112, which in various implementations may include one or more buses, switches, bridges, and/or hybrid interconnects. The other system components coupled to system interconnect 112 can include, for example, a memory controller 114 that controls access by processing units 102 and other components of data processing system 100 to a system memory 116. In addition, data processing system 100 may include an input/output (I/O) adapter 118 for coupling one or I/O devices to system interconnect 112, a non-volatile storage system 120, and a network adapter 122 for coupling data processing system 100 to a communication network (e.g., a wired or wireless local area network and/or the Internet).

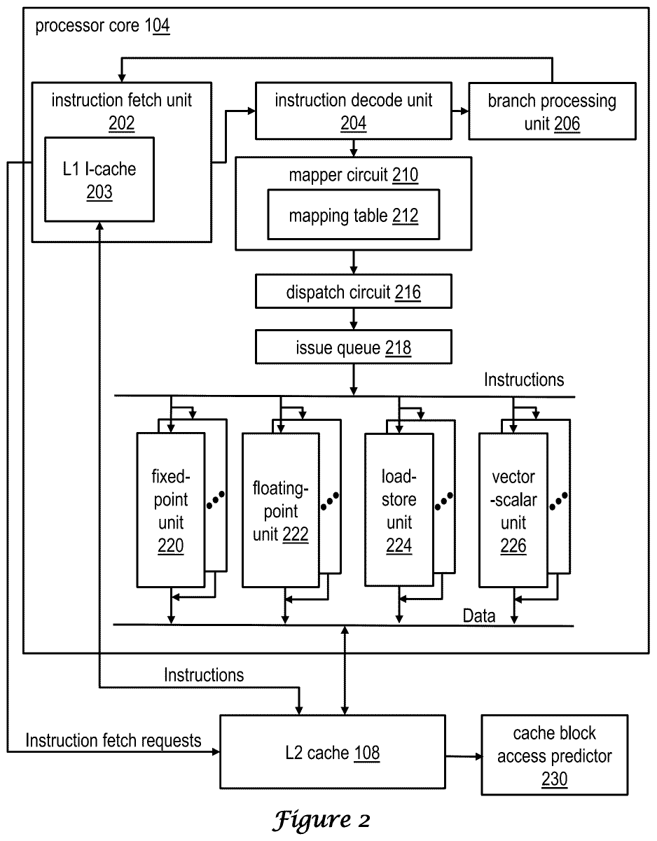

With reference now to FIG. 2, there is depicted a detailed block diagram of processor core 104 in accordance with one embodiment. As shown, processor core 104 includes an instruction fetch unit 202 that fetches instructions within one or more streams of instructions from lower level storage (e.g., L2 cache 108) and buffers fetched instructions in a L1 I-cache 203. Each instruction has a format defined by the instruction set architecture of processor core 104 and includes at least an operation code (opcode) field specifying an operation (e.g., fixed-point or floating-point arithmetic operation, vector operation, matrix operation, logical operation, branch operation, memory access operation, etc.) to be performed by processor core 104. Certain instructions may additionally include one or more operand fields directly specifying operands or implicitly or explicitly referencing one or more core registers storing source operand(s) to be utilized in the execution of the instruction and one or more core registers for storing destination operand(s) generated by execution of the instruction. Instruction decode unit 204, which in some embodiments may be merged with instruction fetch unit 202, decodes the instructions fetched by instruction fetch unit 202 and forwards branch instructions that control the flow of execution to branch processing unit 206 for processing. In some embodiments, the processing of branch instructions performed by branch processing unit 206 may include speculating the outcome of conditional branch instructions. The results of branch processing (both speculative and non-speculative) by branch processing unit 206 may, in turn, be utilized to redirect one or more streams of instruction fetching by instruction fetch unit 202.

Instruction decode unit 204 forwards instructions that are not branch instructions (often referred to as sequential instructions) to mapper circuit 210. Mapper circuit 210 is responsible for the assignment of physical registers within the register files of processor core 104 to instructions as needed to support instruction execution. Mapper circuit 210 preferably implements register renaming. Thus, for at least some classes of instructions, mapper circuit 210 establishes transient mappings between a set of logical (or architected) registers referenced by the instructions and a larger set of physical registers within the register files of processor core 104. As a result, processor core 104 can avoid unnecessary serialization of instructions that are not data dependent, as might otherwise occur due to the reuse of the limited set of architected registers by instructions proximate in program order. Mapper circuit 210 maintains a mapping data structure, referred to herein as mapping table 212, which is utilized to track free physical registers, transient mappings between logical register names and physical registers, and data dependencies between instructions.

Processor core 104 additionally includes a dispatch circuit 216 configured to ensure that any data dependencies between instructions are observed and to dispatch sequential instructions as they become ready for execution. Instructions dispatched by dispatch circuit 216 are temporarily buffered in an issue queue 218 until the execution units of processor core 104 have resources available to execute the dispatched instructions. As the appropriate execution resources become available, issue queue 218 issues instructions from issue queue 218 to the execution units of processor core 104 based on instruction type opportunistically and possibly out-of-order with respect to the original program order of the instructions.

Processor core 104 includes several different types of execution units for executing respective different classes of instructions. In this example, the execution units of processor core 104 include one or more fixed-point units 220 for executing instructions that access fixed-point operands, one or more floating-point units 222 for executing instructions that access floating-point operands, one or more load-store units (LSU) 224 for loading data from and storing data to storage, and one or more vector-scalar units 226 for executing instructions that access vector and/or scalar operands. In this embodiment, each execution unit is implemented as a multi-stage pipeline in which multiple instructions can be simultaneously processed at different stages of execution. Each execution unit preferably includes or is coupled to access at least one register file including a plurality of physical registers for temporarily buffering operands accessed in or generated by instruction execution.

In accordance with a preferred embodiment of the present invention, a cache block access predictor is utilized to predict cache blocks within a cache line to be sent to a processor core after a fetch request by the processor core. The cache block access predictor includes a cache block access tracker and a cache block selector. The cache block access tracker contains a set of counters, each corresponding to the set of cache blocks within a cache line, and the set of counters keeps track of specific one or more cache blocks within the cache line that are actually utilized by the processor core after a fetch request. During a subsequent fetch request for the same cache line by the processor core, instead of sending all the cache blocks within the same cache line, the cache block selector selects only the specific one or more cache blocks to be returned to the requesting processor core.

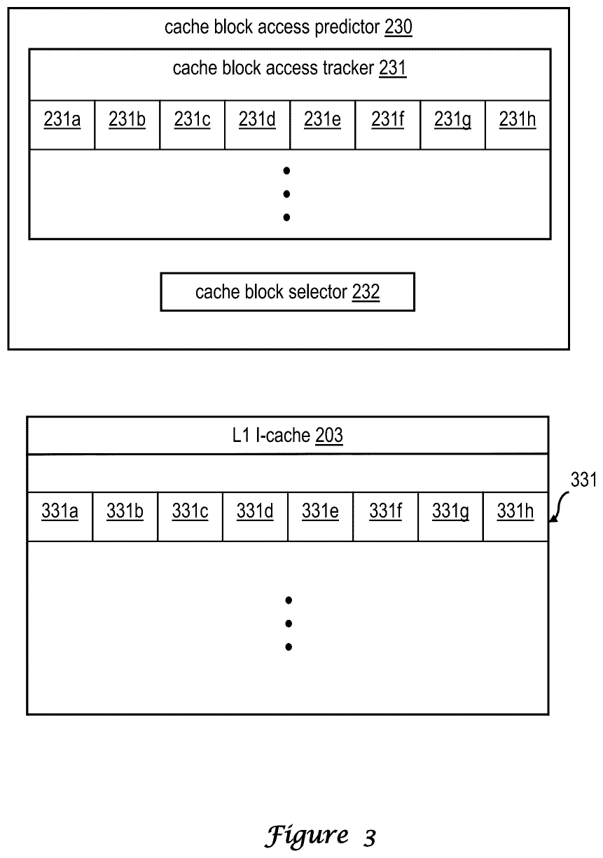

Referring now to FIG. 3, there is depicted a block diagram of a cache block access predictor, according to one embodiment of the present invention. As shown, a cache block access predictor 230 includes a cache block access tracker 231 and a cache block selector 232. For the present embodiment, cache block access predictor 230 is associated with L2 cache 108 in FIG. 2, and cache block access tracker 231 includes eight counters 231a-231h to be associated with one cache line within L2 cache 108. Each of eight counters 231a-231h corresponds to cache blocks 331a-331h, respectively, of the one cache line 331 within L2 cache 108. In this example, a set of eight counters is associated with each cache line because each cache line within L2 cache 108 contains eight blocks. However, if each cache line within L2 cache 108 contains sixteen blocks, then a set of sixteen counters will be utilized to associate with each cache line within L2 cache 108. Counters 231a-231h keep track of the access patterns of cache blocks 331a-331h of cache line 331. Preferably, each of counters 231a-231h is a one-bit counter, but multi-bit counter can also be employed.

There are several ways counters 231a-231h can be updated. In a preferred embodiment, one or more of counters 231a-231h will be incremented in response to a corresponding one or more of cache blocks within cache line 331 being actually utilized by processor core 104 after a fetch request. For example, if cache block 331c of cache line 331 is actually utilized by processor core 104 after a fetch request, then counter 231c will be incremented by 1. If cache blocks 331c and 331g of cache line 331 are actually utilized by processor core 104 after a fetch request, then both counters 231c and 331g will be incremented by 1.

In an alternative embodiment, in addition to updating the counters associated with cache blocks being actually utilized by processor core 104 after a fetch request, the counters associated with cache blocks not actually utilized by processor core 104 after the same fetch request may also be updated to reflect that they are not actually utilized. For example, one or more counters associated with one or more cache blocks actually utilized by processor core 104 after a fetch request may be incremented by 1, while the remaining counters associated with cache blocks not actually utilized by processor core 104 may be reset to 0 or decremented by 1. In the above-mentioned example of cache blocks 331 c and 331g being actually utilized by processor core 104 after a fetch request, counters 231a, 231b, 231d, 231e, 231f and 231h associated with the cache blocks of cache line 331 that are not actually utilized by processor core 104 may be reset to 0 or decremented by 1. Processor core 104 may issue store commands to cache block access tracker 231 to set or reset counters 231a-231h directly.

The above-mentioned cache block access (and non-access) information can be called “cache block access vectors.” Thus, the block access information of each cache line within a cache can be described by using a cache block access vector. For example, if cache blocks 331 c and 331g of cache line 331 are actually utilized by processor core 104 after a fetch request, then the cache block access vector for cache line 331 will be 00100010.

Cache block selector 232 is responsible for selecting the specific one or more cache blocks (instead of all cache blocks) within a cache line to be returned to a processor core in subsequent fetch requests. Cache block selector 232 makes its cache block selection decision based on the cache block access vectors stored within cache block access tracker 231.

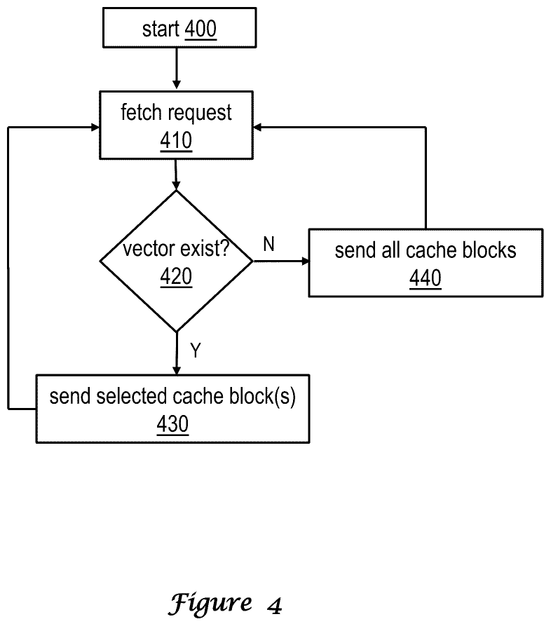

With reference now to FIG. 4, there is illustrated a flowchart of a method for selecting cache blocks within a cache line employed by cache block selector 232, according to one embodiment of the present invention. Starting at block 400, in response to a fetch request for a cache line by a processor core (such as processor core 104), as shown in block 410, a determination is made whether or not a valid cache block access vector for the requested cache line existed within cache block access tracker 231, as depicted in block 420. If a valid cache block access vector for the requested cache line existed within cache block access tracker 231, then cache block selector 232 selects the cache block(s) of the requested cache line according to the information stored within the valid cache block access vector, and sends only the selected cache block(s) (and not all the cache blocks) of the requested cache line to the processor core, as shown in block 430, and the process returns to block 410. Otherwise, if there is no valid cache block access vector (or not access vector) for the requested cache line existed within cache block access tracker 231, then cache block selector 232 sends all the cache blocks within the requested cache line to the processor core, as depicted in block 440, and the process returns to block 410.

Since cache block selector 232 cannot always accurately predict how many cache blocks within a cache line it may need to select, it is desirable to maintain a set of cache block access vector values (within cache block access tracker 231) through multiple accesses to the same cache line. Preferably, the counters within cache block access tracker 231 can be programmed to not decrement on every access. Alternatively, the counters within cache block access tracker 231 can be programmed to reset after a predetermined number of fetch requests has occurred, or after a predetermined amount of time has lapsed.

Cache block access vector values are persisted within a cache hierarchy of a processing unit. If a cache line ages out of the L2 cache and is installed in the L3 cache, cache block access vector values can move with the aged out cache line to the new victim cache location. Therefore, if a fetch request missed in the L2 cache and hit in another cache in the processing unit, cache block access vectors can be utilized to determine which data blocks should be returned to a requesting processor core. The cache block access vectors will then be updated to reflect the installing fetch in preparation for the next cache access. Fetches that miss in the entire cache hierarchy will return all data blocks for the entire cache line and reset the corresponding cache block access vector entry.

In addition to the above-mentioned update algorithm for cache block access tracker 231, a processor core may set or reset an entry of cache block access tracker 231 for a particular line address based off internal-to-core tracked access patterns of the data blocks within the cache line. For example, if fetch line A made 4 fetches, requesting cache block 0, 2, 1 and then 3, processor core 104 may issue a store to write cache block access tracker 231 to set the bits for cache blocks 0-3 and reset the bits for cache blocks 4-7.

When processor core 104 misses, a fetch request enters the cache hierarchy, and processor core 104 makes a request to the next level cache. This lookup typically consists of a fetch command type and the target address. Within the confines of system bussing constraints, fetch requests may be accompanied by additional payload that may assist with the cache processing of the fetch. In the present embodiment, an additional eight-bit vector is utilized. Processor core 104 may use this eight-bit vector to indicate which blocks within a cache line it is explicitly requesting. The vector may be empty, one-hot, have multiple or all bits set.

As soon as the fetch request is detected on the interface from processor core 104, a lookup is made into the cache directory. If the directory results indicate the cache line is in the cache (i.e., cache hit), data will be returned to processor core 104. Cache block access tracker 231 will be looked up in parallel with the lookup directory to determine how many and which of the cache blocks will be returned. In the simple single-bit counter embodiment, any data blocks with a cache block access counter set to “1,” will be returned to processor core 104 in addition to any blocks requested by processor core 104 in the fetch payload vector. Cache blocks that have a counter value of “0” and are not requested specifically by processor core 104 will not be returned. Then, cache block access tracker 231 is updated to reflect the most recent fetch activity.

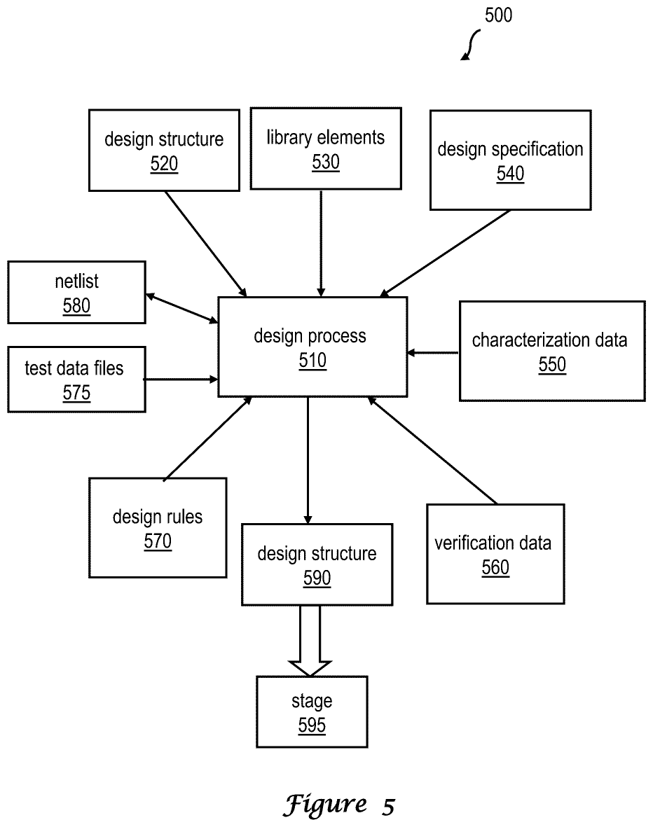

Referring now to FIG. 5, there is illustrated a block diagram of a design flow used in integrated circuit (IC) logic design, simulation, test, layout, and manufacture. As shown, a design flow 500 includes processes, machines and/or mechanisms for processing design structures or devices to generate logically or otherwise functionally equivalent representations of the design structures and/or devices described above and shown herein. The design structures processed and/or generated by design flow 500 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g., a machine for programming a programmable gate array).

Design flow 500 may vary depending on the type of representation being designed. For example, a design flow 500 for building an application specific IC (yASIC) may differ from a design flow 500 for designing a standard component or from a design flow 500 for instantiating the design into a programmable array, for example a programmable gate array (PGA) or a field programmable gate array (FPGA) offered by Altera, Inc. or Xilinx, Inc.

FIG. 5 illustrates multiple such design structures including an input design structure 1020 that is preferably processed by a design process 510. Design structure 520 may be a logical simulation design structure generated and processed by design process 510 to produce a logically equivalent functional representation of a hardware device. Design structure 520 may also or alternatively comprise data and/or program instructions that when processed by design process 510, generate a functional representation of the physical structure of a hardware device. Whether representing functional and/or structural design features, design structure 520 may be generated using electronic computer-aided design (ECAD) such as implemented by a core developer/designer. When encoded on a machine-readable data transmission, gate array, or storage medium, design structure 520 may be accessed and processed by one or more hardware and/or software modules within design process 510 to simulate or otherwise functionally represent an electronic component, circuit, electronic or logic module, apparatus, device, or system such as those shown herein. As such, design structure 520 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 510 preferably employs and incorporates hardware and/or software modules for synthesizing, translating, or otherwise processing a design/simulation functional equivalent of the components, circuits, devices, or logic structures shown herein to generate a netlist 580 which may contain design structures such as design structure 520. Netlist 580 may comprise, for example, compiled or otherwise processed data structures representing a list of wires, discrete components, logic gates, control circuits, I/O devices, models, etc. that describes the connections to other elements and circuits in an integrated circuit design. Netlist 580 may be synthesized using an iterative process in which netlist 580 is resynthesized one or more times depending on design specifications and parameters for the device. As with other design structure types described herein, netlist 580 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 510 may include hardware and software modules for processing a variety of input data structure types including netlist 580. Such data structure types may reside, for example, within library elements 530 and include a set of commonly used elements, circuits, and devices, including models, layouts, and symbolic representations, for a given manufacturing technology (e.g., different technology nodes, 32 nm, 45 nm, 50 nm, etc.). The data structure types may further include design specifications 540, characterization data 550, verification data 560, design rules 570, and test data files 575 that may include input test patterns, output test results, and other testing information. Design process 510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 510 without deviating from the scope and spirit of the invention. Design process 510 may also include modules for performing standard circuit design processes such as timing analysis, verification, design rule checking, place and route operations, etc.

Design process 510 employs and incorporates logic and physical design tools such as HDL compilers and simulation model build tools to process design structure 520 together with some or all of the depicted supporting data structures along with any additional mechanical design or data (if applicable), to generate a second design structure 590. Design structure 590 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to design structure 520, design structure 590 preferably comprises one or more files, data structures, or other computer-encoded data or instructions that reside on transmission or data storage media and that when processed by an ECAD system generate a logically or otherwise functionally equivalent form of one or more of the embodiments of the invention shown herein. In one embodiment, design structure 590 may comprise a compiled, executable HDL simulation model that functionally simulates the devices shown herein.

Design structure 590 may also employ a data format used for the exchange of layout data of integrated circuits and/or symbolic data format (e.g., information stored in a GDSII (GDS2), GL1, OASIS, map files, or any other suitable format for storing such design data structures). Design structure 590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown herein. Design structure 590 may then proceed to a stage 595 where, for example, design structure 590: proceeds to tape-out, is released to manufacturing, is released to a mask house, is sent to another design house, is sent back to the customer, etc.

As has been described, the present invention provides an improved method and apparatus for handling fetch requests by a processor.

While the invention has been particularly shown and described with reference to a preferred embodiment, it will be understood by those skilled in the art that various changes in form and detail may be made therein without departing from the spirit and scope of the invention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A processing unit comprising:
a processor core;
a cache having a plurality of cache lines, wherein one of said cache lines includes a plurality of cache blocks; and
a cache block access predictor includes
a cache block access tracker having a plurality of counters, each corresponding to said plurality of cache blocks, wherein said plurality of counters keeps track of specific one or more cache blocks within a cache line that are actually utilized by said processor core after a fetch request; and
a cache block selector for selecting only said specific one or more cache blocks, instead of all cache blocks within said cache line, to be returned to said processor core in a subsequent fetch request for said cache line.

2. The processing unit of claim 1, wherein one of said counters is incremented in response to a corresponding one of said cache blocks being actually utilized by said processor core.

3. The processing unit of claim 2, wherein the rest of said counters is decremented in response to corresponding said cache blocks not being actually utilized by said processor core.

4. The processing unit of claim 1, wherein said counters are set not to increment on every fetch request.

5. The processing unit of claim 1, wherein said counters are reset after a predetermined number of fetch requests have occurred.

6. The processing unit of claim 1, wherein said counters are reset after a predetermined amount of time has lapsed.

7. The processing unit of claim 1, wherein information of said counters is transferrable from one cache to another cache located at a different level or levels.

8. A method for predicting blocks within a cache line for fetch requests, said method comprising:
associating a cache block access tracker with a cache having a plurality of cache lines, wherein one of said cache lines includes a plurality of cache blocks;
providing a plurality of counters within said cache block access tracker, each corresponding to said plurality of cache blocks, wherein said plurality of counters keeps track of specific one or more cache blocks within a cache line that are actually utilized by a processor core after a fetch request; and
selecting only said specific one or more cache blocks, instead of all cache blocks within said cache line, to be returned to said processor core in a subsequent fetch request for said cache line by said processor core.

9. The method of claim 8, further comprising incrementing one of said counters in response to a corresponding one of said cache blocks being actually utilized by said processor core.

10. The method of claim 9, further comprising decrementing the rest of said counters in response to corresponding said cache blocks not being actually utilized by said processor core.

11. The method of claim 8, further comprising not incrementing said counters on every fetch request.

12. The method of claim 8, further comprising resetting said counters after a predetermined number of fetch requests have occurred.

13. The method of claim 8, further comprising resetting said counters after a predetermined amount of time has lapsed.

14. The method of claim 8, wherein information of said counters is transferrable from one cache to another cache located at a different level or levels.

15. A design structure tangibly embodied in a machine-readable storage device for designing, manufacturing, or testing an integrated circuit, said design structure comprising:
an integrated circuit, including:
a semiconductor substrate;
a processor core on said semiconductor substrate;
a cache on said semiconductor substrate, wherein said cache includes a plurality of cache lines, wherein one of said cache lines includes a plurality of cache blocks; and
a cache block access predictor on said semiconductor substrate, wherein said cache block access predictor includes
a cache block access tracker having a plurality of counters, each corresponding to said plurality of cache blocks, wherein said plurality of counters keeps track of specific one or more cache blocks within a cache line that are actually utilized by said processor core after a fetch request; and
a cache block selector for selecting only said specific one or more cache blocks, instead of all cache blocks within said cache line, to be returned to said processor core in a subsequent fetch request for said cache line.

16. The design structure of claim 15, wherein one of one of said counters is incremented in response to a corresponding one of said cache blocks being actually utilized by said processor core.

17. The design structure of claim 16, wherein the rest of said counters are decremented in response to corresponding said cache blocks not being actually utilized by said processor core.

18. The design structure of claim 15, wherein said counters are not incremented on every fetch request.

19. The design structure of claim 15, wherein said counters are reset after a predetermined number of fetch requests have occurred.

20. The design structure of claim 15, wherein said counters are reset after a predetermined amount of time has lapsed.
